(19) United States
(12) Patent Application Publication
(10) Pub. No.: US 2025/0349219 A1
(43) Pub. Date: Nov. 13, 2025

(54) ANOMALY DETECTION DEVICE FOR AN AIRCRAFT AND RELATED METHODS

(71) Applicant: EAGLE TECHNOLOGY, LLC, MELBOURNE, FL (US)

(72) Inventors: MARK D. RAHMES, MELBOURNE, FL (US); KEVIN R. NIEWOEHNER, STAFFORD, VA (US); KEVIN L. FOX, PALM BAY, FL (US); CHRISTOPHER JASON BERGER, LEESBURG, VA (US); ERTON BOCI, BROADLANDS, VA (US)

(21) Appl. No.: 18/055,990

(22) Filed: Nov. 16, 2022

(51) Int. Cl. G08G 5/54; G01S 19/42; G06N 3/0455; G06N 3/08; G08G 5/21

(52) U.S. Cl. CPC G08G 5/54; G01S 19/42; G06N 3/0455; G06N 3/08; G08G 5/21

(57) ABSTRACT

An anomaly detection device for an aircraft may include a memory and a processor configured to receive satellite position data collected by the aircraft and comprising a sequence of aircraft positions defining an aircraft trajectory, and process the satellite position data using a plurality of different deep learning models to determine respective aircraft trajectory anomalies in a runway approach flight path for the aircraft. The processor may be further configured to select a given deep learning model that most accurately determines the anomalies in the runway approach flight path based upon a game theoretic model, and generate an alert if the respective anomaly in the runway approach flight path determined by the given deep learning model exceeds a threshold.

### TECHNICAL FIELD

The present disclosure relates to computing devices, and, more particularly, to machine learning (ML) systems for determining aircraft navigation anomalies and related methods.

### BACKGROUND

Adversarial attacks may sometimes be used to trick a system into making a false determination by providing faulty input. In the case of ML models, in some cases it may be possible to trick them into making false predictions by slightly modifying the input. These modifications can be imperceptible. As such, there may be a risk when deploying such models in the production environment, of exploitation and unintended consequences.

Adversarial examples can be generated effectively by adding small amounts of perturbations or by slightly modifying the values along a limited number of dimensions of the input. These subtle modifications make them difficult to detect, and the ML models may classify them incorrectly resulting in problems with how the model synthesizes inputs, focuses attention, and learns semantics.

One application where adversarial attacks may be of particular concern is aircraft navigation, in particular aircraft approaches and landings. Various approaches have been developed for determining aircraft descent anomalies. For example, U.S. Pat. No. 9,051,058 to Caule et al. discloses an aircraft ground or sea approach anomaly detection method which includes steps of characterizing a flight phase of the aircraft, determining a prohibited flight envelope, defining a set of prohibited vertical speeds of the aircraft for given altitudes in relation to the ground or the sea, as a function of the flight phase of the aircraft characterized, and detecting a ground approach anomaly of the aircraft as a function of a current vertical speed and altitude in relation to the ground or the sea of the aircraft, in relation to the prohibited flight envelope determined.

Despite the advantages of such systems, further developments in aircraft approach anomaly detection may be desirable.

### SUMMARY

An anomaly detection device for an aircraft may include a memory and a processor configured to receive satellite position data collected by the aircraft and including a sequence of aircraft positions defining an aircraft trajectory, and process the satellite position data using a plurality of different deep learning models to determine respective aircraft trajectory anomalies in a runway approach flight path for the aircraft. The processor may be further configured to select a given deep learning model that most accurately determines the anomalies in the runway approach flight path based upon a game theoretic model, and generate an alert if the respective anomaly in the runway approach flight path determined by the given deep learning model exceeds a threshold.

In an example implementation, the aircraft trajectory may comprise a vector, and the processor may be further configured to resample the vector to normalize timing and velocity. In some embodiments, the processor may be further configured to generate distorted aircraft trajectory data, and process the satellite position data and distorted aircraft trajectory data using the plurality of different deep learning models to determine the aircraft trajectory anomalies.

In an example embodiment, the processor may be further configured to implement a variational autoencoder (VAE) to analyze a latent space vector to gather confidence metrics for the game theoretic model. More particularly, the VAE may include an encoder configured to generate a mean vector and a standard deviation vector from the satellite position data, and generate the latent vector from the mean vector and the standard deviation vector.

By way of example, the plurality of different deep learning models may include at least one of Adaptive Moment Estimation (ADAM), Stochastic Gradient Descent with Momentum (SGDM), and RMSProp deep learning models. Furthermore, the processor may be configured to solve the game theoretic model using a linear program, for example. Also by way of example, the position data may comprise Global Positioning System (GPS) data. In some embodiments, the anomaly detection device may further include a housing carrying the memory and processor and configured to be mounted within the aircraft.

A related anomaly detection method may include, at an anomaly detection device for an aircraft, receiving satellite position data collected by the aircraft and comprising a sequence of aircraft positions defining an aircraft trajectory, and processing the satellite position data using a plurality of different deep learning models to determine respective aircraft trajectory anomalies in a runway approach flight path for the aircraft. The method may further include, at the anomaly detection device, selecting a given deep learning model that most accurately determines the anomalies in the runway approach flight path based upon a game theoretic model, and generating an alert if the respective anomaly in the runway approach flight path determined by the given deep learning model exceeds a threshold.

A related non-transitory computer-readable medium may have computer-executable instructions for causing an anomaly detection device for an aircraft to perform steps including receiving satellite position data collected by the aircraft and comprising a sequence of aircraft positions defining an aircraft trajectory, and processing the satellite position data using a plurality of different deep learning models to determine respective aircraft trajectory anomalies in a runway approach flight path for the aircraft. The steps may further include selecting a given deep learning model that most accurately determines the anomalies in the runway approach flight path based upon a game theoretic model, and generating an alert if the respective anomaly in the runway approach flight path determined by the given deep learning model exceeds a threshold.

### BRIEF DESCRIPTION OF THE DRAWINGS

FIG. 1 is a schematic block diagram of an anomaly detection device in accordance with an example embodiment.

FIG. 2 is a flow diagram illustrating signal distortion detection operations which may be performed by the anomaly detection device of FIG. 1.

FIG. 3 is a flow diagram illustrating trajectory anomaly detection operations which may be performed by the anomaly detection device of FIG. 1.

FIG. 4 is a schematic block diagram of an example implementation of the anomaly detection device of FIG. 1.

FIG. 5 is a flow diagram illustrating method aspects associated with the anomaly detection device of FIG. 1.

### DETAILED DESCRIPTION

By way of background, adversarial attacks may be generated effectively by adding small amounts of perturbations, or even by just slightly modifying the values along a limited number of dimensions of the input to a ML model. These subtle modifications may make them difficult to detect by humans, yet the models classify them incorrectly with high confidence thereby challenging our understanding of how the model synthesizes inputs, focuses attention, and learns semantics.

Attack samples may be generated in a way that manipulates the model to output the exact incorrect class as intended by the adversary. This opens up the possibility of severe manipulation of the system instead of simply breaking it. Furthermore, adversarial examples generated for one model may potentially deceive networks with different architectures trained on the same task. Even more surprisingly, these different models often agree with each other on the incorrect class. This property allows attackers to use a surrogate model (not necessarily the same architecture or even the same class of algorithm) as an approximation to generate attacks for the target model.

There are currently no widely accepted theories on why adversarial attacks work so effectively. Several hypotheses have been put forward such as linearity, invariance and non-robust features leading to development of several defense mechanisms, but none of them have acted as a panacea for generating robust models and resilient defenses.

With respect to adversarial attacks in navigation applications, Global Positioning System (GPS) spoofing may be a serious issue since its compromise can cause ships to run aground and aircraft to enter into restricted space. GPS signals are also fairly easy to deceive. In a GPS spoofing scenario, a GPS spoofer sends out bogus signals to convince a GPS receiver that it is in a different location than where it actually is.

Maneuverable trajectory prediction is an active field of study. Many numerical and analytical approaches are used. One example is Predictive Bank (PB), which is based upon a constant bank angle propagation to centroid of aircraft. Another approach is Straight Propagation (SP), which is based upon a constant heading propagation to centroid of aircraft. Still another approach is Batch Propagation (BP), which informs the propagation from historical dynamic/energy observations. However, such techniques do not provide a comprehensive approach to determine aircraft approach anomalies.

Generally speaking, the approach set forth herein advantageously helps address a technical problem of defending against a GPS attack by detecting GPS signal distortion and training an artificial intelligence (AI) model to defend against the attack. The model that can detect an attack may then be used in a system to look for real trajectory anomalies to provide a safety system for aircraft, especially during the elevated risk portion of flight, e.g. an airport runway approach and landing.

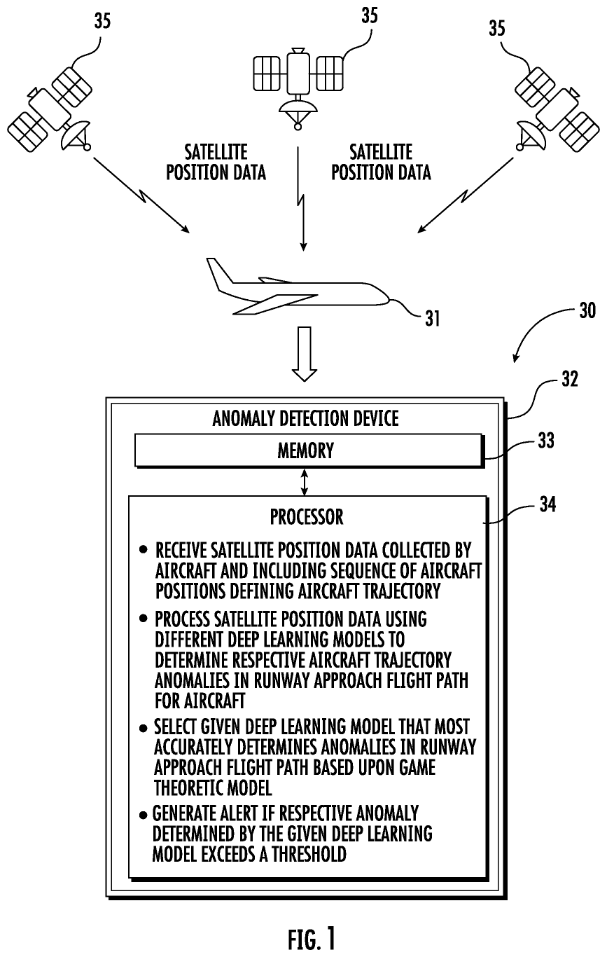

Referring now to FIG. 1, an anomaly detection device 30 for an aircraft 31 is first described. The device 31 illustratively includes a housing 32, and a memory 33 and a processor 34 carried by the housing. In an example embodiment, the housing 32 may be configured to be mounted or carried on the airplane 31, although in some embodiments the device 31 may be located at a ground station, or its various operations may be distributed across different computing devices at different locations (e.g., onboard the airplane 31 and on the ground, in a cloud configuration, etc.). The processor 34 is configured to receive position data (e.g., Global Positioning System (GPS) data) sourced from satellites 35 collected by the aircraft 31 and including a sequence of aircraft positions defining an aircraft trajectory (and in some embodiments departure sequence waypoints as defined in the approach/departure procedures), and process the satellite position data using a plurality of different deep learning models to determine respective aircraft trajectory anomalies in a runway approach flight path for the aircraft. The processor 34 is further configured to select a given deep learning model that most accurately determines the anomalies in the runway approach flight path based upon a game theoretic model, and generate an alert. The alert will be triggered if the respective anomaly in the runway approach flight path, as determined by the given deep learning model, exceeds an operational threshold.

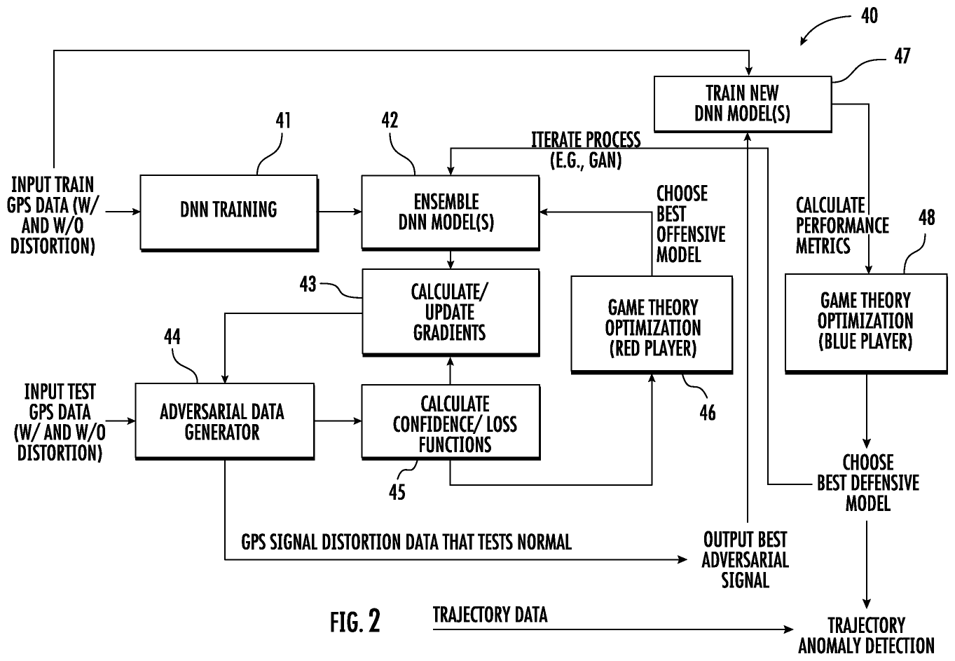

Referring additionally to the flow diagram 40 of FIG. 2, example GPS signal distortion detection operations which may be performed by the anomaly detection device 30 are now described. At Block 41, GPS signals are input into a deep neural network (DNN) as training data. The GPS data represents signals with and without adversarial spoofing distortion. As noted above, GPS spoofing is when the signal is altered so that a device appears in a different location. At Block 42, the DNN learns what are normal and distorted GPS signals, and an ensemble of deep learning models are generated with different solvers to classify these signals between normal and distorted. By way of example, the different deep learning models may include one or more of Adaptive Moment Estimation (ADAM), Stochastic Gradient Descent with Momentum (SGDM), and RMSProp deep learning models, although other suitable deep learning models may also be used in different embodiments.

At Block 43, distorted signals are generated from the normal signals, and the distorted signals which test normal are used as test data. An adversarial attack may be considered as a technique to find a perturbation that changes the prediction of a machine learning model. As such, at Block 44, distorted signals are generated by iteratively modifying the normal gradients of the models towards the distorted classification. Gradient based attacks use this concept to develop a perturbation vector for the input signal by making a slight modification to the back-propagation algorithm. At Block 45, confidence and loss metrics are calculated and used to determine accuracy and stopping metrics. A VAE may be used to analyze latent space to gather confidence metrics for a game theoretic optimization (GTO) process (Block 46), as will be discussed further below. The GTO selects the best adversarial model which creates distorted signals that test normal.

At Block 47, a new set of DNN models are then trained to learn how to best detect distorted signals which test normal. A GTO is also used to select the best defensive model which detects distortion from an ensemble of different solvers (e.g., ADAM, SGDM, and RMSProp), at Block 48. The illustrated process may then be repeated (e.g., as in a Generative Adversarial Network (GAN)) iteratively to create successively-optimized adversarial models, as well as defensive models. The GAN may include two neural networks (adversarial and defensive) which contest each other in a zero-sum game. The final result is a DNN which can reliably detect the presence of GPS distortion so that aircraft trajectory anomaly detection process flow may be performed with confidence.

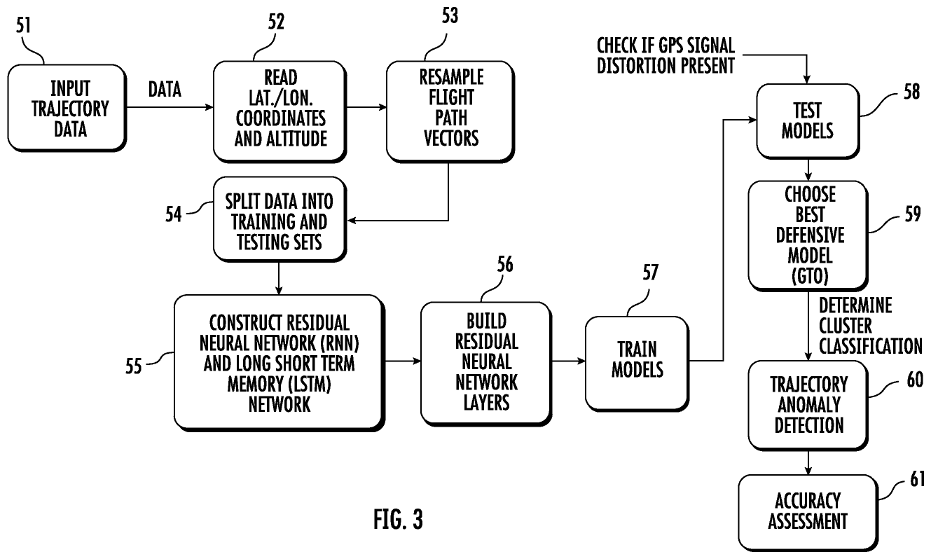

Referring additionally to the flow diagram 50 of FIG. 3, an example aircraft trajectory anomaly detection process is now described. The process starts (Block 51) with providing positional (e.g., GPS) information data as input trajectory data, which includes a state vector composition of sequential latitudes, longitudes, and altitudes as input data into an ensemble of DNNs, at Block 52. At Block 53, the vector may be resampled to normalize timing and velocity samples. At Block 54, normal and abnormal trajectory data are input into DNNs as training data and testing data. At Block 55, the DNNs use convolutional neural network (CNN) or long short-term memory (LSTM) architectures from which a residual neural network is constructed (Block 56). At Block 57, the DNNs learn to distinguish anomalies.

If it has been determined that GPS spoofing is not present, then the trajectory anomaly detection process can occur with confidence based on true positional information (Block 58). At Block 59, a GTO is used to choose which solver (e.g., ADAM, SGDM, RMSProp) most accurately classifies anomalies in runway approach flight path. At Block 60, a VAE may be used to analyze the latent space to gather confidence metrics for the GTO process, as well as to analyze latent space for anomalies. Accuracy assessment may then be measured using Receiver Operating Characteristic (ROC) curves to show probability of detection and false alarm, for example (Block 61).

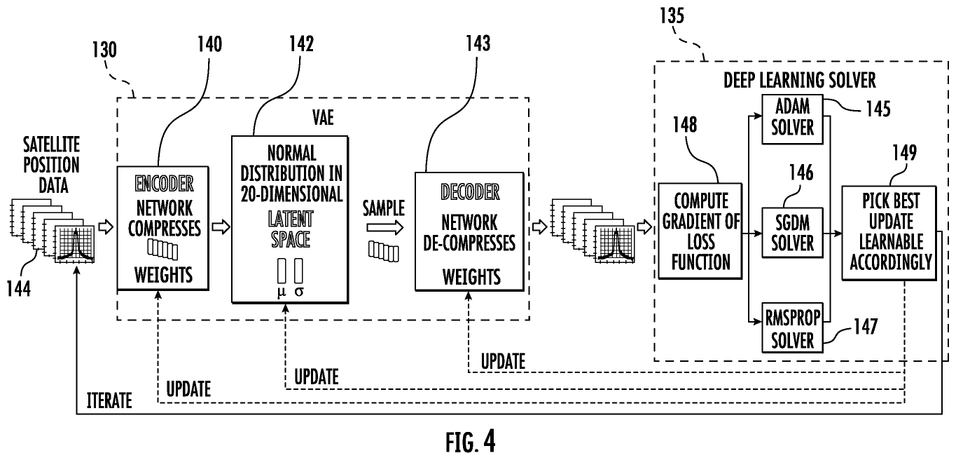

An example implementation of the processor 34 to implement a VAE 130 and a deep learning solver 135 is now described with reference to FIG. 4. The VAE 130 includes illustratively an encoder 140 which learns to compress (reduce) a batch of position input data 144 into an encoded representation of a normal distribution in latent space provided by a neural network 142 (e.g., a convolutional neural network, CNN). A decoder 143 learns to reconstruct the original data from the encoded representation to be as close to the original input as possible. The latent space is the layer that contains the compressed representation of the input data.

The VAE 130 differs from regular autoencoders in that it does not use the encoding-decoding process simply to reconstruct an input. Instead, the VAE 130 imposes a probability distribution on the latent space and learns the distribution so that the distribution of the outputs from the decoder 143 matches that of the observed data. The VAE 130 assumes that the source data has some sort of underlying probability distribution (such as Gaussian) and then attempts to find the parameters of the distribution.

The illustrated configuration advantageously provides an effective way to generate synthetic data for training ML applications, such as the above-described anomaly detection. In particular, this may be done while maintaining the underlying statistical properties of the original dataset. Furthermore, it may be applicable to sensitive datasets where traditional data-masking falls short of protecting the data, and it may provide faster methods of generating synthetic training data for ML applications.

By way of background, a VAE is a generative system, and serves a similar purpose as a generative adversarial network. One main use of a VAE is to generate new data that is related to the original source data by sampling from the learned distribution. Utilizing the learned distribution provides a way of generating synthetic data that is reflective of naturally occurring variations, rather than simply replicating existing data samples. This new synthetic data may be utilized for additional training and testing analysis. Moreover, a VAE is a generative model which may randomly generate new samples based on the learned distribution. However, unlike traditional generative models that require strong assumptions regarding data structures and long inference times, a VAE makes weak assumptions of the data which also leads to faster training.

The VAE 130 forces input images onto an n-dimensional probability distribution, (e.g., a 20-dimensional Gaussian spread in the present example), learns the associated parameters (e.g., the means and variances for a Gaussian distribution), and describes the position data with the resulting distribution. Synthetic data samples may be randomly generated from a probability distribution lens in latent space once the associated parameter state vectors are calculated.

The controller 133 may utilize a two-step process to generate synthetic data samples by (1) using the VAE 130 to learn the statistical properties of the original dataset(s) sampled from the Operational Design Domain (ODD); and (2) using the deep learning solver 135 as an optimizer for sampling the learned distribution and applying algorithmic transformations (e.g., rotations, reflections and attenuation) that enable building of richer datasets to support the ML model Verification and Validation (V&V) process. More particularly, this approach provides an enhanced VAE-based process flow to learn the distribution and associated statistical properties of the original dataset (ideally the distribution of data in the ODD). Input data is provided, which in the present example includes satellite position data 144.

Generally speaking, input data may come from signals or other data that is converted to 2D imagery to leverage the convolutional neural network(s) 142 which underlies the VAE 130. The input data can represent any aspect or aspects of one or more devices and/or processes of a distributed system of interest. In the example of a computer network, the data includes overall network performance, individual device performance, performance of multiple devices clustered together, usage parameters such as bandwidth usage or CPU (central processing unit) usage, memory usage, connectivity issues, Wi-Fi coverage, cellular signal, syslog, Netflow, data logs, intrusion detection system alerts and more.

For image-based inputs, an image gradient Sobel edge detector may be used as a pre-processing step. This preprocessing step helps the Deep Learning Convolutional Neural Network models to learn more quickly and with more accuracy. Next, the data is provided to the encoder 140 of the VAE 130. The encoder 140 forces the input data 144 onto the multidimensional probability distribution. In the present example, this is a 20-dimensional multivariate Gaussian distribution, although other distributions and dimensions may be utilized in different embodiments. The VAE 130 learns the means and variances of the data, and the resulting distribution describes the data.

The encoder 140 generates a compressed representation of the input data utilizing various weights and biases. Weights are the parameters within the neural network 142 that transform input data within the network's hidden layers. Generally speaking, the neural network 142 is made up of a series of nodes. Within each node is a set of inputs, weight, and a bias value. As an input enters the node, it gets multiplied by a weight value, and the resulting output is either observed or passed to the next layer in the neural network 142. The weights of the neural network 142 may be included within the hidden layers of the network. Within the neural network 142, an input layer may take the input signals and pass them to the next layer. Then, the neural network 142 includes a series of hidden layers which apply transformations to the input data. It is within these nodes of the hidden layers that the weights are applied. For example, a single node may take the input data and multiply it by an assigned weight value, then add a biasing residue before passing the data to the next layer. The final layer of the neural network 142 is known as the output layer. The output layer often tunes the inputs from the hidden layers to produce the desired numbers in a specified range.

Weights and bias values are both learnable parameters inside the network 142. The neural network 142 may randomize both the weight and bias values before initial learning. As training continues, both parameters may be adjusted toward the desired values and the correct output. The two parameters differ in the extent of their influence upon the input data. At its simplest, bias represents how far off the predictions are from their intended value. Biases make up the difference between the function's output and its intended output. A low bias suggests that the network 142 is making more assumptions about the form of the output, whereas a high bias value makes less assumptions about the form of the output. Weights, on the other hand, can be thought of as the strength of the connection. Weight affects the amount of influence a change in the input will have upon the output. A low weight value will have no change on the input, and alternatively a larger weight value will change the output more significantly.

The compressed representation of the input data is called the hidden vector. The mean and variance from the hidden vector are sampled and learned by the CNN 142. Principal component analysis (PCA) of the hidden vector allows for the visualization of n-dimensional point clusters, e.g., 3-D point clusters, in the latent space. To make calculations more numerically stable, the range of possible values may be increased by making the network learn from the logarithm of the variances. Two vectors may be defined: one for the means, and one for the logarithm of the variances. Then, these two vectors may be used to create the distribution from which to sample.

The decoder 143 generates synthetic output data. The deep learning solver 135 functions as an optimizer which uses an ensemble of solvers 145-147 with a game theoretic implementation to create an output image with minimal image reconstruction error. An input module 148 computes a gradient of loss function from the synthetic output data, and an output module 149 picks the best update based upon the solvers 145-147. More particularly, the optimizer process is iterated via re-parameterization to handle sampling of the hidden vector during backpropagation (an algorithm for training neural networks). In the illustrated example, an ensemble of models is generated using the three different solvers, namely an ADAM solver 145, an SGDM solver 146, and an RMSProp solver 147, although different solvers may be used in different embodiments. The values from the loss function (evidence lower bound or ELBO, reconstruction, and Kullback-Leibler or KL loss) may be used in a game theoretic implementation to determine the optimal model to use per test sample. The loss is used to compute the gradients of the solvers.

To summarize, the processor 34 illustrated in FIG. 4 performs the following steps:
a) Providing position input data to the encoder 140 of the VAE 130;
b) Compressing the position input data using a first set of weights with the encoder;
c) Creating a normal distribution of the compressed position data in a latent space of the VAE;
d) Decompressing the compressed position data from the latent space using a second set of weights with the decoder 143 of the VAE;
e) Optimizing the decompressed position data from the decoder, which may further include (i) generating multiple probabilistic models of the decoded position data, and (ii) determining which of the multiple models is optimal by applying a game theoretic optimization to select which model to use;
f) Updating at least the first and second set of weights based on the loss detected in the optimized decompressed image data, which may include (i) applying a game theoretic optimization to the models; and (ii) selecting which model (e.g., ADAM, SGDM, or RMSProp) to use to update the first and second sets of weights; and
g) Iterate steps b)-f) until the decompressed position data possesses substantially the same statistical (quasi-deterministic behavior) properties as the input image data (such statistics include ELBO loss, which is reconstruction loss plus KL loss).
   Steps b)-f) may be iterated until the error does not statistically decrease and validation patience is achieved (i.e., the number of times that the validation loss can be larger than or equal to the previously smallest loss before network training stops).

Once the latent space distribution of the original dataset has been learned/optimized, synthetic datasets may be generated. For example, a sample may be randomly generated from the learned distribution in latent space. Next, the decoder 143 may be applied to the sample to generate a new datum. Afterwards, algorithmic transformations may be applied, as appropriate, to generate additional data points for the validation test dataset. Multiple transformations may be applied to a single sample from the latent space distribution, to quickly increase the size of a synthetic dataset.

An example CNN neural network architecture which may be used by the anomaly detection device 30 is as follows:

layers_resnet = [
imageInputLayer([height,width,channels],‘Name’,‘input’)
convolution2dLayer([2 128],32,‘Padding’,‘same’,‘Name’,‘convInp’)
batchNormalizationLayer(‘Name’,‘BNInp’)
reluLayer(‘Name’,‘reluInp’)
convolutionalUnitv2(32,1,‘S1U1’)
additionLayer(2,‘Name’,‘add11’)
reluLayer(‘Name’,‘relu11’)
convolutionalUnitv2(32,1,‘S1U2’)
additionLayer(2,‘Name’,‘add12’)
reluLayer(‘Name’,‘relu12’)
maxPooling2dLayer([1 2],‘Name’, ‘MaxPooling1’,‘Stride’,[1 2])
convolutionalUnitv2(32,1,‘S2U1’)
additionLayer(2,‘Name’,‘add21’)
reluLayer(‘Name’,‘relu21’)
convolutionalUnitv2(32,1,‘S2U2’)
additionLayer(2,‘Name’,‘add22’)
reluLayer(‘Name’,‘relu22’)
maxPooling2dLayer([1 2],‘Name’, ‘MaxPooling2’,‘Stride’,[1 2])
convolutionalUnitv2(32,1,‘S3U1’)
additionLayer(2,‘Name’,‘add31’)
reluLayer(‘Name’,‘relu31’)
convolutionalUnitv2(32,1,‘S3U2’)
additionLayer(2,‘Name’,‘add32’)
reluLayer(‘Name’,‘relu32’)
maxPooling2dLayer([1 2],‘Name’, ‘MaxPooling3’,‘Stride’,[1 2])
convolutionalUnitv2(32,1,‘S4U1’)
additionLayer(2,‘Name’,‘add41’)
reluLayer(‘Name’,‘relu41’)
convolutionalUnitv2(32,1,‘S4U2’)
additionLayer(2,‘Name’,‘add42’)
reluLayer(‘Name’,‘relu42’)
];
maxPooling2dLayer([1 2],‘Name’, ‘MaxPooling4’, ‘Stride’,[1 2])
convolutionalUnitv2(32,1,‘S5U1’)
additionLayer(2,‘Name’,‘add51’)
reluLayer(‘Name’,‘relu51’)
convolutionalUnitv2(32,1,‘S5U2’)
additionLayer(2,‘Name’,‘add52’)
reluLayer(‘Name’,‘relu52’)
maxPooling2dLayer([1 2],‘Name’, ‘MaxPooling5’,‘Stride’,[1 2])
convolutionalUnitv2(32,1,‘S6U1’)
additionLayer(2,‘Name’,‘add61’)
reluLayer(‘Name’,‘relu61’)
convolutionalUnitv2(32,1,‘S6U2’)
additionLayer(2,‘Name’,‘add62’)
reluLayer(‘Name’,‘relu62’)
maxPooling2dLayer([1 2],‘Name’, ‘MaxPooling6’,‘Stride’,[1 2])
fullyConnectedLayer(128,‘Name’,‘fc1’)
dropoutLayer(0.1,‘Name’,‘dropout 1’)
fullyConnectedLayer(128,‘Name’,‘fc2’)
dropoutLayer(0.1,‘Name’,‘dropout 2’)
fullyConnectedLayer(2,‘Name’,‘fcFinal’)
softmaxLayer(‘Name’,‘softmax’)
classificationLayer(‘Name’,‘classoutput’)

An example LSTM neural network architecture which may be used by the anomaly detection device 30 is as follows:

layers = [
% add sequence layer to allow time-series input
sequenceInputLayer([height,width,channels], ‘Name’, ‘input’)
% flatten to 1-D for input into LSTM
flattenLayer(‘Name’,‘flatten’)
% add bidirectional LSTM layer
bilstmLayer(128,‘Name’,‘lstml’, ‘OutputMode’, ‘last’)
% add dropout layer to stochastically set 10% of LSTM weights to
zero
% during training only
dropoutLayer(0.1,‘Name’,‘drop1’)
% add fully connected layer with 10% dropout
fullyConnectedLayer(128,‘Name’,‘fc2’)
dropoutLayer(0.1,‘Name’,‘drop2’)
% add another fully connected layer to output scores
fullyConnectedLayer(4,‘Name’,‘fcFinal’);
% output the classification
softmaxLayer(‘Name’,‘softmax’)
classificationLayer(‘Name’,‘classoutput’)
];

The GTO may utilize a reward matrix with position values and different solvers. More particularly, an M×C matrix is constructed, where M is the number of models in the ensemble and C is the number of classes. In an example implementation, there may be a model for each solver, for a total of three models in the case of ADAM, SGDM, and RMSProp. The matrix is then solved for each pixel.

In an example implementation, the reward matrix uses reconstruction and KL loss scores, or responses based on the number of pixel values. Scores are used in a linear program to optimize selection of the deep learning model best-suited to use per pixel. The matrix may be constructed and solved with a linear program. By way of example, an interior-point algorithm (e.g., the primal-dual method) may be used, which should be feasible for convergence. The primal standard form may be used to calculate optimal tasks and characteristics as follows:

$$maximize f ( x ) s . t .$$

$$Ax \leq b$$

$$x \geq 0$$

The above-described approach utilizes AI/ML algorithms to gain leverage and learn from the environment and predict flight patterns. Past performance of runway approach patterns is used to predict future flight accuracy through estimation of the current state based on position, velocity, acceleration. Future state predictions are based on quiescent parameters including flight standards, current state-vector and obstacles; convolved with dynamical factors including weather, adjacent traffic, flight dynamic constraints, and past operation behaviors. This approach advantageously provides several technical advantages, such as serving as an advisory system for early prediction of anomalous flight patterns. The anomaly detection device 30 may further provide independent real time flight operations risk assessment. This risk assessment includes the ability to provide operational integration with current and future FAA flight standards, and flight system behavior coupled with Automation, Communication, Navigation, and Surveillance infrastructure.

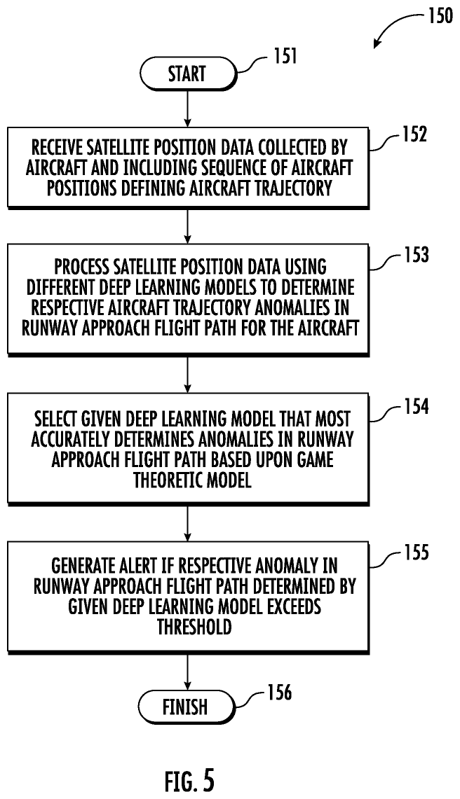

Turning to the flow diagram 150 of FIG. 5, a related method is now described. Beginning at Block 151, the anomaly detection device 30 receives satellite position data collected by the aircraft 31 and including a sequence of aircraft positions defining an aircraft trajectory, at Block 152. The anomaly detection device 30 further processes the satellite position data using a plurality of different deep learning models to determine respective aircraft trajectory anomalies in a runway approach flight path for the aircraft, at Block 153. The method further includes, at the anomaly detection device 30, selecting a given deep learning model that most accurately determines the anomalies in the runway approach flight path based upon a game theoretic model, at Block 154, and generating an alert if the respective anomaly in the runway-approach flight path determined by the given deep learning model, exceeds a threshold (Block 155). The method of FIG. 5 illustratively concludes at Block 156.

A related non-transitory computer-readable medium may have computer-executable instructions for causing an anomaly detection device 30 for an aircraft 31 to perform steps including receiving satellite position data collected by the aircraft and including a sequence of aircraft positions defining an aircraft trajectory, and processing the satellite position data using a plurality of different deep learning models to determine respective aircraft trajectory anomalies in a runway approach flight path for the aircraft. The steps may further include selecting a given deep learning model that most accurately determines the anomalies in the runway approach flight path based upon a game theoretic model, and generating an alert if the respective anomaly in the runway approach flight path determined by the given deep learning model exceeds a threshold.

Many modifications and other embodiments will come to the mind of one skilled in the art, having the benefit of the teachings presented in the foregoing descriptions and the associated drawings. Therefore, it is understood that the disclosure is not to be limited to the specific embodiments disclosed, and that modifications and embodiments are intended to be included within the scope of the appended claims.

1. An anomaly detection device for an aircraft comprising:
a memory and a processor configured to
receive satellite position data collected by the aircraft and comprising a sequence of aircraft positions defining an aircraft trajectory,
process the satellite position data using a plurality of different deep learning models to determine respective aircraft trajectory anomalies in a runway approach flight path for the aircraft,
select a given deep learning model that most accurately determines the anomalies in the runway approach flight path based upon a game theoretic model, and
generate an alert if the respective anomaly in the runway approach flight path determined by the given deep learning model exceeds a threshold.

2. The anomaly detection device of claim 1 wherein the aircraft trajectory comprises a state-vector; and wherein the processor is further configured to resample the state-vector to normalize timing and velocity.

3. The anomaly detection device of claim 1 wherein the processor is further configured to generate distorted aircraft trajectory data, and process the satellite position data convolved with the distorted aircraft trajectory data using the plurality of different deep learning models to determine the aircraft trajectory anomalies.

4. The anomaly detection device of claim 1 wherein the processor is further configured to implement a variational autoencoder (VAE) to analyze a latent space vector to gather confidence metrics for the game theoretic model.

5. The anomaly detection device of claim 4 wherein the VAE comprises an encoder configured to generate a mean vector and a standard deviation vector from the satellite position data, and generate the latent vector from the mean vector and the standard deviation vector.

6. The anomaly detection device of claim 1 wherein the plurality of different deep learning models comprises at least one of Adaptive Moment Estimation (ADAM), Stochastic Gradient Descent with Momentum (SGDM), and RMSProp deep learning models.

7. The anomaly detection device of claim 1 wherein the processor is configured to solve the game theoretic model using a linear program.

8. The anomaly detection device of claim 1 wherein the satellite position data comprises Global Positioning System (GPS) data.

9. The anomaly detection device of claim 1 further comprising a housing carrying the memory and processor, the housing configured to be mounted within the aircraft.

10. An anomaly detection method comprising:
at an anomaly detection device for an aircraft,
receiving satellite position data collected by the aircraft and comprising a sequence of aircraft positions defining an aircraft trajectory,
processing the satellite position data using a plurality of different deep learning models to determine respective aircraft trajectory anomalies in a runway approach flight path for the aircraft,
selecting a given deep learning model that most accurately determines the anomalies in the runway approach flight path based upon a game theoretic model, and
generating an alert if the respective anomaly in the runway approach flight path determined by the given deep learning model exceeds a threshold.

11. The method of claim 10 wherein the aircraft trajectory comprises a vector; and further comprising, at the anomaly detection device, resampling the vector to normalize timing and velocity.

12. The method of claim 10 further comprising, at the anomaly detection device, generating distorted aircraft trajectory data, and processing the satellite position data and distorted aircraft trajectory data using the plurality of different deep learning models to determine the aircraft trajectory anomalies.

13. The method of claim 10 further comprising, at the anomaly detection device, implementing a variational autoencoder (VAE) to analyze a latent space vector to gather confidence metrics for the game theoretic model.

14. The method of claim 10 wherein the plurality of different deep learning models comprises at least one of Adaptive Moment Estimation (ADAM), Stochastic Gradient Descent with Momentum (SGDM), and RMSProp deep learning models.

15. The method of claim 10 wherein selecting further comprises solving the game theoretic model using a linear program.

16. A non-transitory computer-readable medium having computer-executable instructions for causing an anomaly detection device for an aircraft to perform steps comprising:
receiving satellite position data collected by the aircraft and comprising a sequence of aircraft positions defining an aircraft trajectory;
processing the satellite position data using a plurality of different deep learning models to determine respective aircraft trajectory anomalies in a runway approach flight path for the aircraft;
selecting a given deep learning model that most accurately determines the anomalies in the runway approach flight path based upon a game theoretic model; and
generating an alert if the respective anomaly in the runway approach flight path determined by the given deep learning model exceeds a threshold.

17. The non-transitory computer-readable medium of claim 16 wherein the aircraft trajectory comprises a vector; and further having computer-executable instructions for causing the anomaly detection device to perform a step of resampling the vector to normalize timing and velocity.

18. The non-transitory computer-readable medium of claim 16 further having computer-executable instructions for causing the anomaly detection device to perform steps comprising generating distorted aircraft trajectory data, and processing the satellite position data and distorted aircraft trajectory data using the plurality of different deep learning models to determine the aircraft trajectory anomalies.

19. The non-transitory computer-readable medium of claim 16 further having computer-executable instructions for causing the anomaly detection device to perform a step of implementing a variational autoencoder (VAE) to analyze a latent space vector to gather confidence metrics for the game theoretic model.

20. The non-transitory computer-readable medium of claim 16 wherein the plurality of different deep learning models comprises at least one of Adaptive Moment Estimation (ADAM), Stochastic Gradient Descent with Momentum (SGDM), and RMSProp deep learning models.

21. The non-transitory computer-readable medium of claim 16 wherein selecting further comprises solving the game theoretic model using a linear program.
